(19) United States
(12) Patent Application Publication
(10) Pub. No.: US 2023/0177470 A1
(43) Pub. Date: Jun. 8, 2023

(54) INFORMATION PROCESSING SYSTEM, INFORMATION OUTPUT METHOD, AND NON-TRANSITORY RECORDING MEDIUM

(71) Applicant: Tsutomu Kinomoto, Kanagawa (JP)

(72) Inventor: Tsutomu Kinomoto, Kanagawa (JP)

(73) Assignee: Ricoh Company, Ltd., Tokyo (JP)

(21) Appl. No.: 17/970,009

(22) Filed: Oct. 20, 2022

(30) Foreign Application Priority Data
Dec. 2, 2021 (JP) 2021-196279

(51) Int. Cl. G06Q 10/10

(52) U.S. Cl. CPC G06Q 10/1091

(57) ABSTRACT

An information processing system includes circuitry that acquires usage amount information from an apparatus via a network. The usage amount information is related to a usage amount of the apparatus. The circuitry further totals the usage amount for a time range, and outputs the totaled usage amount in association with the time range.

### CROSS-REFERENCE TO RELATED APPLICATION

This patent application is based on and claims priority pursuant to 35 U.S.C. §119(a) to Japanese Patent Application No. 2021-196279, filed on Dec. 2, 2021, in the Japan Patent Office, the entire disclosure of which is hereby incorporated by reference herein.

### BACKGROUND

### Technical Field

Embodiments of this disclosure relate to an information processing system, an information output method, and a non-transitory recording medium.

### Related Art

There is an information processing system that communicates with an apparatus via a network to acquire various apparatus information such as counter information and job logs from the apparatus and manage the apparatus. The information processing system creates a report on a usage amount by totaling the counter information, for example.

There is also a technique of creating the usage amount report without a response to a counter request from the apparatus. For example, when the apparatus responds to a counter request, the counter information may be held as cache counter information so that the usage amount report is created with the cache counter information.

The above-described technique, however, does not support the totaling of the usage amount for a certain time range in a day.

### SUMMARY

In one embodiment of this invention, there is provided an information processing system that includes, for example, circuitry that acquires usage amount information from an apparatus via a network. The usage amount information is related to a usage amount of the apparatus. The circuitry further totals the usage amount for a time range, and outputs the totaled usage amount in association with the time range.

In one embodiment of this invention, there is provided an information output method that includes, for example, acquiring usage amount information from an apparatus via a network. The usage amount information is related to a usage amount of the apparatus. The information output method further includes totaling the usage amount for a time range, and outputting the totaled usage amount in association with the time range.

In one embodiment of this invention, there is provided a non-transitory recording medium which, when executed by one or more processors, causes the processors to perform the above-described information output method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating examples of a time range for which a report is desired to be created;

FIG. 2 is a diagram illustrating an example of the general arrangement of an apparatus management system according to a first embodiment of the present invention;

FIG. 3 is a diagram illustrating an example of the hardware configuration of an information processing system and a terminal apparatus included in the apparatus management system of the first embodiment;

FIG. 4 is a diagram illustrating an example of the hardware configuration of an image forming apparatus as an example of an apparatus included in the apparatus management system of the first embodiment;

FIG. 5 is a functional block diagram illustrating an example of functional blocks of the information processing system, the terminal apparatus, and the apparatus of the first embodiment;

FIG. 6 is a diagram illustrating an example of cycle information and time range information stored in a report creation condition storage unit included in the information processing system of the first embodiment;

FIG. 7 and FIG. 8 are diagrams illustrating an example of counter information stored in a counter information storage unit included in the information processing system of the first embodiment;

FIG. 9 is a diagram illustrating an example of a setting screen displayed by the terminal apparatus of the first embodiment;

FIG. 10 is a sequence diagram illustrating an example of a process of the first embodiment in which the information processing system totals the counter information with the time range information;

FIG. 11 is a diagram illustrating an example of a report created by an information output unit included in the information processing system of the first embodiment;

FIG. 12 is a diagram illustrating an example of the general arrangement of the apparatus management system according to a second embodiment of the present invention;

FIG. 13 is a functional block diagram illustrating an example of functional blocks of the information processing system, the terminal apparatus, the apparatus, an in-house information management system, and a world wide web (Web) server included in the apparatus management system of the second embodiment;

FIG. 14 is a diagram illustrating an example of acquisition source information stored in the report creation condition storage unit included in the information processing system of the second embodiment;

FIG. 15 is a diagram illustrating an example of business hours stored in a business hour information storage unit included in the in-house information management system of the second embodiment;

FIG. 16 is a diagram illustrating an example of the setting screen displayed by the terminal apparatus of the second embodiment;

FIG. 17 is a sequence diagram illustrating an example of a process of the second embodiment in which the information processing system totals the counter information with the time range information;

FIG. 18 is a diagram illustrating an example of job logs stored in the counter information storage unit included in the information processing system according to a third embodiment of the present invention; and

FIG. 19 is a sequence diagram illustrating an example of a process of the third embodiment in which the information processing system totals a print page count with the time range information.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, an information processing system and an information output method performed thereby are described below as exemplary embodiments of the present disclosure. As used herein, the singular forms “a,” “an,” and “the” are intended to include the plural forms as well, unless the context clearly indicates otherwise.

An overview of the creation of a report will be described.

Herein, counter information refers to the cumulative print page count, i.e., the number of pages printed in the past, of an apparatus at a certain time. An information processing system communicating with the apparatus collects the counter information from the apparatus, and totals the counter information by apparatus, department, or company, for example. The value of the totaled counter information will be referred to as the usage amount. The usage amount is used to charge the customer of the apparatus for the lease of the apparatus, with the fee for the usage being included in the charge, or is used to determine the maintenance time of the apparatus, for example.

The counter information is typically totaled separately for monochrome printing and color printing. Separately from or in addition to the counter information, information related to print job, such as print page count, user identifier (ID) or user name, print time, and print settings, may also be collected. The information processing system stores such information as job logs and totals the job logs to find detailed usage of the apparatus, such as the usage of two-sided printing and the usage of multiple-pages-per-side printing, as well as the usage amount.

When a user wants to know the usage amount during a certain period, the usage amount during the period is typically calculated based on the counter information from 00 seconds, 00 minutes, 00 hours on the start date of the period to 59 seconds, 59 minutes, 23 hours on the end date of the period.

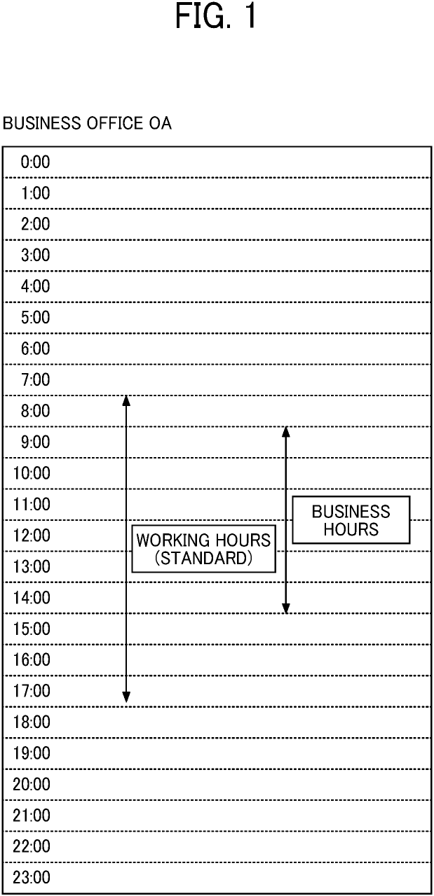

The user may also want to know the usage amount during a particular time range in a day or the usage amount based on the printing purpose. An example of such a case will be described below with reference to FIG. 1.

FIG. 1 illustrates examples of the time range in a day (hereinafter simply referred to as the time range) for which a report is desired to be created. As a business style of a company, the company may conduct business at a business office different from the head office of the company. For example, employees of a travel agency or an insurance agency often talk with customers at a business office or a branch of the company.

FIG. 1 illustrates an example of the time range of working hours and the time range of business hours at a certain business office (hereinafter referred to as the business office OA). The business office OA desires to create a report separately totaling the print page count of prints performed outside the business hours and the print page count of prints performed during the business hours. This is because, according to the account classification in corporate accounting, print costs generated outside the business hours are categorized as general and administrative expenses, while print costs generated during the business hours are categorized as distribution and operating expenses.

Business offices under the same head office may have different business hours. When a business office is housed in a large commercial facility, for example, the business hours of the business office are restricted by those of the commercial facility. Further, the business hours of each of the business offices may be set by the local manager of the business office.

It is therefore desirable that the respective business hours of the business offices are managed by the information processing system. If a business office is not housed in a large commercial facility, for instance, the business hours of the business office are fixed and thus may be input to the information processing system by a system administrator of the information processing system, for example. If a business office is housed in a large commercial facility, the information processing system may acquire the business hours of the business office from a world wide web (Web) page of the commercial facility or the business office that provides the information of the business hours. Alternatively, the information processing system may acquire the business hours of the respective business offices from a database of the head office.

The information processing system thus acquires the business hours and outputs the report by time range such as the business hours.

Herein, the term “usage amount” refers to the amount of use of an apparatus. If the apparatus is a printer, the usage amount may be the number of printed pages (one side of a sheet is counted as one page). The usage amount may vary depending on the apparatus. For example, the usage amount may be the operating time, the power consumption, the data communication amount, or the carbon dioxide emission amount. The term “time range” refers to the range of time from a certain time to another time. The term “user” refers to an employee or system administrator who uses a terminal apparatus at a business office. The user may be an employee of a company operating the information processing system. The term “information related to the usage amount” (usage amount information) refers to the usage amount of an apparatus or information convertible into the usage amount of an apparatus. In embodiments of the present invention, the counter information or the job logs will be described as an example of the information related to the usage amount.

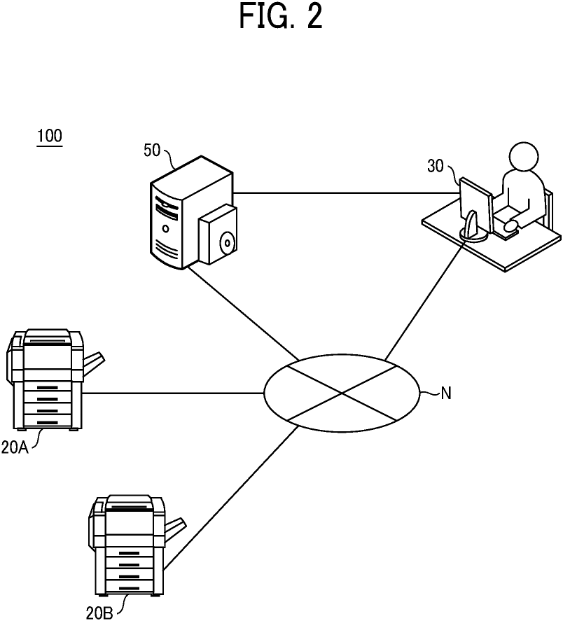

An example of the system configuration of an apparatus management system 100 according to a first embodiment of the present invention will be described with reference to FIG. 2.

FIG. 2 is a diagram illustrating an example of the general arrangement of the apparatus management system 100 according to the first embodiment. In this example, a network N connected to one or more local area networks (LANs) is built in a company. The network N may include the Internet and a wide-area LAN connected to the respective LANs at a plurality of locations. The network N, which is a wired or wireless network, is connected to an apparatus (same-brand apparatus) 20A and an apparatus (different-brand apparatus) 20B. Hereinafter, the apparatus (same-brand apparatus) 20A or the apparatus (different-brand apparatus) 20B will be simply described as the apparatus 20 where the distinction therebetween is unnecessary.

The apparatus 20 is connected to the network N via a network interface card (NIC) such as an Ethernet® card. The apparatus 20 thus connected to the network N may be called a network apparatus, i.e., an apparatus that performs communication in accordance with the transmission control protocol (user datagram protocol)/internet protocol (TCP(UDP)/IP).

Herein, the same-brand apparatus refers to the apparatus 20 manufactured or distributed by a company operating a later-described information processing system 50 or by a company related to the operating company. The different-brand apparatus refers to the apparatus 20 manufactured or distributed by a company other than the company operating the information processing system 50 or the company related to the operating company.

As the apparatuses 20, the apparatus (same-brand apparatus) 20A and the apparatus (different-brand apparatus) 20B may be similar in function. Although there may be a difference between the apparatus (same-brand apparatus) 20A and the apparatus (different-brand apparatus) 20B, the information processing system 50 is capable of acquiring from the apparatus (different-brand apparatus) 20B at least the counter information thereof. The apparatus 20 includes a multifunction peripheral/printer/product (MFP), a printer, a printing machine, an image forming apparatus, and a facsimile (FAX) machine, for example. The apparatus 20 may be any apparatus from which the information related to the usage amount is acquirable, such as a projector, an electronic whiteboard, a video conference terminal, a router, or a hub device, for example.

The network N is further connected to the information processing system 50 and a terminal apparatus 30. The information processing system 50 is implemented by one or more information processing apparatuses. The information processing system 50 acquires the counter information from the apparatuses 20 with a protocol such as the simple network management protocol (SNMP). The information processing system 50 preferably has the function of a Web server. The information processing system 50 provides a report to the terminal apparatus 30 via a Web page. The information processing system 50 totals the counter information by totaling period (e.g., day or month) specified by the user, and also totals the counter information by time range. The information processing system 50 may also total the counter information by user, department, or apparatus, for example.

The information processing system 50 may be located on the Internet or in an on-premise environment. If located on the Internet, the information processing system 50 is preferably compatible with cloud computing. The term “cloud” is used where no particular hardware resource is assumed.

The terminal apparatus 30 may be a general-purpose information processing apparatus. In accordance with a user operation, the terminal apparatus 30 acquires the report from the information processing system 50 and displays the acquired report on a Web browser running on the terminal apparatus 30.

The terminal apparatus 30 is not necessarily required to be a separate information processing apparatus, and may be a console connected to the information processing system 50. Herein, the console refers to an input and output device, which typically includes a keyboard and a display.

The information processing system 50 creates the report as follows.

The information processing system 50 periodically collects the counter information from the apparatuses 20 and previously stores the collected counter information in a storage device such as a hard disk. Then, the user sets report creation conditions, such as creating the report by user, department, apparatus, or totaling period (e.g., day or month). The information processing system 50 then creates the report based on the report creation conditions set as described above.

The information processing system 50 therefore creates various reports, such as a counter report by user, a counter report by department, and a counter report by apparatus.

In above-described process of setting the report creation conditions, the user sets time range information (hereinafter referred to as the first case), or the user sets an acquisition source from which the time range information is to be acquired (hereinafter referred to as the second case).

In the first case, the terminal apparatus 30 displays a setting screen acquired from the information processing system 50. Then, when inputting the report creation conditions on the setting screen, the user sets the time range for which the counter information is to be totaled.

In the second case, the terminal apparatus 30 displays the setting screen acquired from the information processing system 50. Then, when inputting the report creation conditions on the setting screen, the user sets acquisition source information of an acquisition source that publishes the business hours of the business office. The acquisition source may be an in-house information management system or a Web server, which will be described later. The information processing system 50 acquires the time range information from the set acquisition source.

A method used in the first case will be described in the first embodiment, and a method used in the second case will be described later in a second embodiment of the present invention.

An exemplary hardware configuration of each of the information processing system 50 and the terminal apparatus 30 will be described.

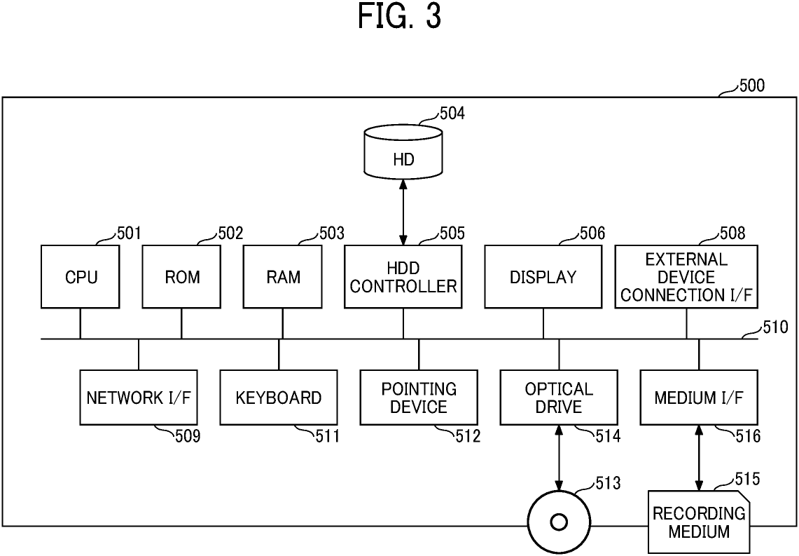

FIG. 3 is a diagram illustrating an exemplary hardware configuration of each of the information processing system 50 and the terminal apparatus 30 in the first embodiment. Each of the information processing system 50 and the terminal apparatus 30 is implemented by a computer 500 illustrated in FIG. 3. The computer 500 includes a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls overall operation of the computer 500. The ROM 502 stores a program used to drive the CPU 501, such as an initial program loader (IPL). The RAM 503 is used as a working area of the CPU 501. The HD 504 stores various data of programs, for example. The HDD controller 505 controls writing and reading of various data to and from the HD 504 under the control of the CPU 501. The display 506 displays various information such as a cursor, menus, windows, text, and images. The external device connection I/F 508 is an interface for connecting various external devices to the computer 500. The external devices in this case include a universal serial bus (USB) memory and a printer, for example. The network I/F 509 is an interface for performing data communication via the network N. The bus line 510 includes address buses and data buses for electrically connecting the CPU 501 and the other components in FIG. 3 to each other.

The keyboard 511 is an input device including a plurality of keys used to input text, numerical values, and various instructions, for example. The pointing device 512 is an input device used to select and execute various instructions, select a processing target, or move the cursor, for example. The optical drive 514 controls writing and reading of various data to and from an optical storage medium 513 as an example of a removable recording medium. The optical storage medium 513 is a compact disc (CD), a digital versatile disk (DVD), or a Blu-ray™ disc, for example. The medium I/F 516 controls writing (i.e., storage) and reading of data to and from a recording medium 515 such as a flash memory.

An exemplary hardware configuration of the apparatus 20 will be described.

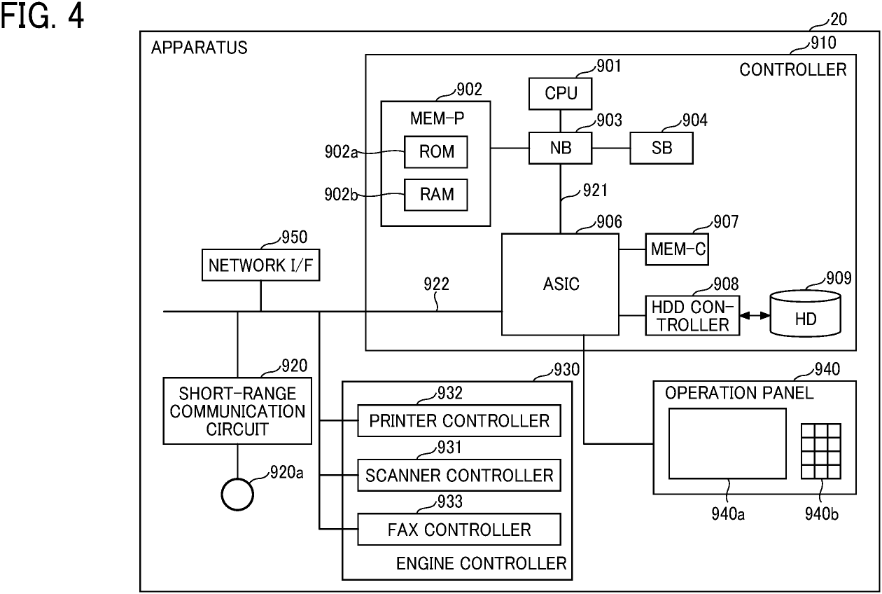

FIG. 4 is a diagram illustrating a hardware configuration of an image forming apparatus as an example of the apparatus 20. As illustrated in FIG. 4, the image forming apparatus (i.e., the apparatus 20) includes a controller 910, a short-range communication circuit 920, an engine controller 930, an operation panel 940, and a network I/F 950.

The controller 910 includes a CPU 901 as a major component of a computer forming the image forming apparatus, a system memory (MEM-P) 902, a north bridge (NB) 903, a south bridge (SB) 904, an application specific integrated circuit (ASIC) 906, a local memory (MEM-C) 907 serving as a storage device, an HDD controller 908, and an HD 909 serving as a storage device. The NB 903 and the ASIC 906 are connected to each other by an accelerated graphics port (AGP) bus 921.

The CPU 901 is a control device that performs overall control of the image forming apparatus. The NB 903 is a bridge for connecting the CPU 901, the MEM-P 902, the SB 904, and the AGP bus 921 to each other. The NB 903 includes a memory controller that controls data writing and reading to and from the MEM-P 902, a peripheral component interconnect (PCI) master, and an AGP target.

The MEM-P 902 includes a ROM 902a and a RAM 902b. The ROM 902a is a memory for storing programs and data for implementing the functions of the controller 910. The RAM 902b is used as a memory in deploying a program or data or as a rendering memory in memory printing, for example. Each of the programs stored in the ROM 902a may be provided as recorded on a computer readable recording medium, such as a CD-ROM, a CD-recordable (CD-R), or a DVD, in an installable or executable file format.

The SB 904 is a bridge for connecting the NB 903 to a PCI device or a peripheral device. The ASIC 906, which is an integrated circuit (IC) for image processing, includes hardware components for image processing. The ASIC 906 functions as a bridge for connecting the AGP bus 921, a PCI bus 922, the HDD controller 908, and the MEM-C 907 to each other. The ASIC 906 includes a PCI target, an AGP master, an arbiter as a core component of the ASIC 906, a memory controller that controls the MEM-C 907, a plurality of direct memory access controllers (DMACs) that perform processes such as the rotation of image data with a hardware logic, and a PCI unit that transfers data to and from a scanner controller 931, a printer controller 932, or a FAX controller 933 of the engine controller 930 via the PCI bus 922. The ASIC 906 may include a USB interface and an institute of electrical and electronics engineers (IEEE) 1394 interface.

The MEM-C 907 is a local memory used as a copy image buffer and a code buffer. The HD 909 is a storage device for storing image data, font data for use in printing, and form data. The HDD controller 908 controls data writing and reading to and from the HD 909 under the control of the CPU 901. The AGP bus 921 is a bus interface for a graphics accelerator card proposed to speed up graphics processing. The AGP bus 921 enables the graphics accelerator card to directly access the MEM-P 902 with a high throughput, thereby implementing a high-speed graphics accelerator card.

The short-range communication circuit 920 includes an antenna 920a for a short-range communication circuit. The short-range communication circuit 920 is a communication circuit conforming to a standard such as near field communication (NFC) or Bluetooth®.

The engine controller 930 includes the scanner controller 931, the printer controller 932, and the FAX controller 933. The operation panel 940 includes a panel display 940a and hardware keys 940b. The panel display 940a is implemented by, for example, a touch panel that displays the current setting values and a selection screen and receives an input from an operator (i.e., user). The hardware keys 940b include numeric keys for receiving the setting values of conditions related to image formation such as a density setting condition and a start key for receiving a copy start instruction, for example. The controller 910 controls the entire image forming apparatus to control rendering, communication, and input via the operation panel 940, for example. Each of the scanner controller 931, the printer controller 932, and the FAX controller 933 includes an image processing section that performs processing such as error diffusion and gamma conversion.

With an application switch key included in the operation panel 940, the function of the image forming apparatus is sequentially switched to a document box function, a copier function, a printer function, and a FAX function to select a desired function. When the user selects the document box function, the image forming apparatus is switched to document box mode. When the user selects the copier function, the image forming apparatus is switched to copy mode. When the user selects the printer function, the image forming apparatus is switched to printer mode. When the user selects the FAX function, the image forming apparatus is switched to FAX mode.

The network I/F 950 is an interface for performing data communication via the network N. The network I/F 950 and the short-range communication circuit 920 are electrically connected to the ASIC 906 via the PCI bus 922.

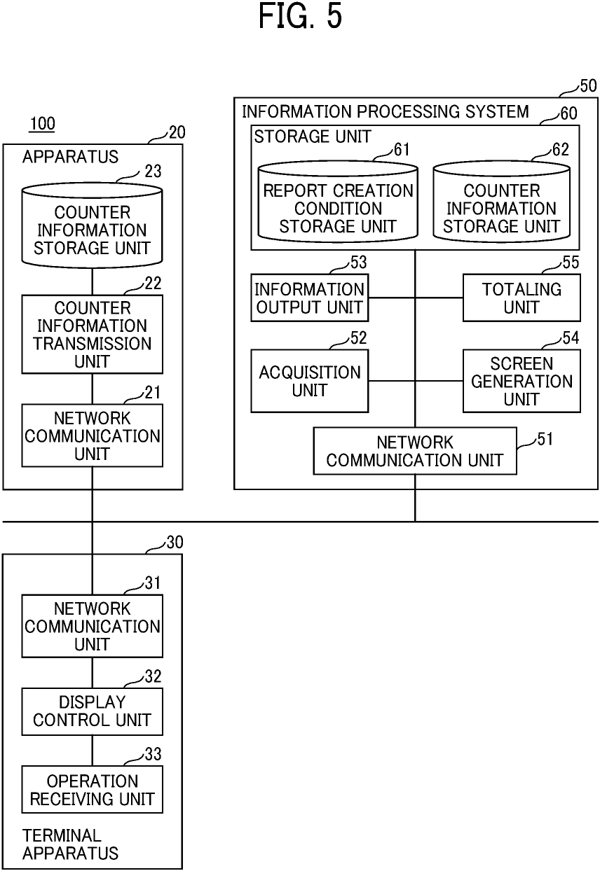

Functions of the apparatus management system 100 of the first embodiment will be described with reference to FIG. 5.

FIG. 5 is a functional block diagram illustrating an example of functional blocks of the information processing system 50, the terminal apparatus 30, and the apparatus 20 according to the first embodiment.

The information processing system 50 includes a network communication unit 51, an acquisition unit 52, an information output unit 53, a screen generation unit 54, a totaling unit 55, and a storage unit 60. These functional units of the information processing system 50 are functions or means implemented by the CPU 501 in FIG. 3 executing commands included in one or more programs installed in the information processing system 50. The storage unit 60 includes a report creation condition storage unit 61 and a counter information storage unit 62, which are implemented by the HD 504 and the RAM 503 in FIG. 3, for example.

The network communication unit 51 connects to the network N and performs communication in accordance with the respective communication protocols of the layers in networking, such as the data link layer, the network layer, the transport layer, and the session layer.

The acquisition unit 52 acquires the counter information from the apparatus 20 by periodically requesting the counter information from the apparatus 20, for example. Information such as the time interval or time of the periodical request and the IP address of the apparatus 20 is previously set. The network communication unit 51 may acquire the counter information from the apparatus 20 with the SNMP, for example. An apparatus or software that acquires apparatus information from the apparatus 20 with the SNMP is called an SNMP manager. Instead of the acquisition unit 52 requesting the counter information, the apparatus 20 may periodically and automatically transmit the counter information to the information processing system 50. In this case, information such as the time interval or time of the periodical transmission and the IP address of the information processing system 50 is previously set in the apparatus 20.

The screen generation unit 54 provides the function of a Web server. In response to a request from the terminal apparatus 30, the screen generation unit 54 provides screen information to be displayed as a Web page. The screen information is a program described in hypertext markup language (HTML), extensible markup language (XML), scripting language, and cascading style sheet (CSS), for example. Typically, the structure of the Web page is specified in HTML, and the operation of the Web page is specified in scripting language. Further, the style of the Web page is specified in CSS.

The totaling unit 55 totals the counter information acquired by the acquisition unit 52 by totaling period specified by the user (e.g., day or month). The totaling unit 55 further totals the counter information by time range. The totaling unit 55 may also total the counter information by user, department, or apparatus, for example.

The information output unit 53 creates a report including the totaling result. The report may be created in the portable document format (PDF), or may be created on the Web page displayed by the terminal apparatus 30.

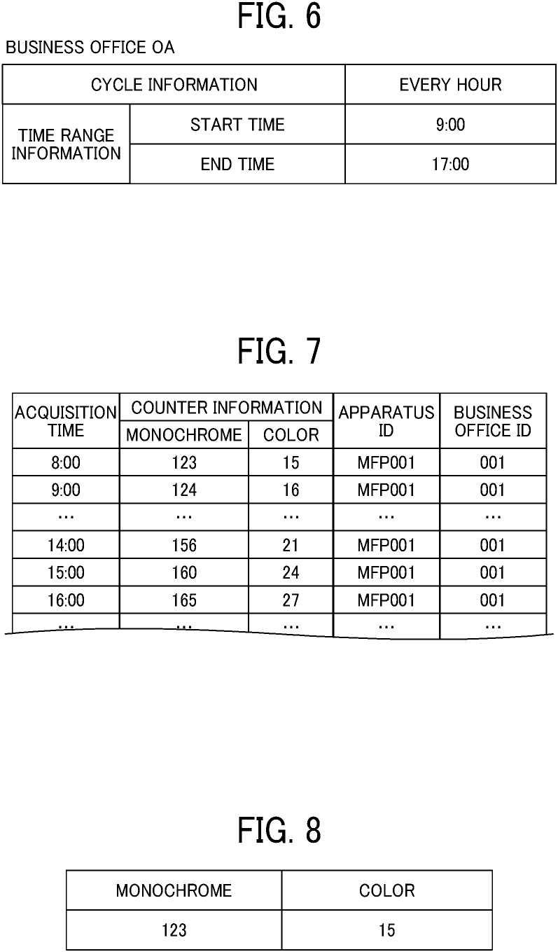

FIG. 6 illustrates an example of cycle information and time range information stored in the report creation condition storage unit 61. The cycle information represents the time interval for the information processing system 50 to acquire the counter information from the apparatus 20. The example of FIG. 6, in which the cycle information is set to “every hour,” is illustrative. The cycle information may be specified not as the time interval but as the time (i.e., the times at which the information processing system 50 is scheduled to acquire the counter information from the apparatus 20).

The time range information includes a start time and an end time. The start time represents the time at which the business hours start, and the end time represents the time at which the business hours end. The time range information corresponds to the business hours of the business office set on the setting screen by the user. The apparatus 20 is installed in the business office.

FIG. 7 illustrates an example of the counter information stored in the counter information storage unit 62. The counter information of monochrome printing and the counter information of color printing are registered in association with an acquisition time. Each counter information is associated with an apparatus ID and a business office ID. The report for each apparatus 20 is created with the apparatus ID, and the report for each business office is created with the business office ID. If one business office has more than one department, the counter information may also be associated with a department ID.

The example of FIG. 7, in which the counter information is acquired every hour, is illustrative. The counter information is acquired periodically in accordance with the cycle information set by the user.

Referring back to FIG. 5, the apparatus 20 includes a network communication unit 21, a counter information transmission unit 22, and a counter information storage unit 23. These functional units of the apparatus 20 are functions or means implemented by the CPU 901 in FIG. 4 executing commands included in one or more programs installed in the apparatus 20. The counter information storage unit 23 is implemented by the HD 909 and the RAM 902b in FIG. 4, for example.

The function of the network communication unit 21 may be similar to that of the network communication unit 51 of the information processing system 50.

In response to the request from the information processing system 50, the counter information transmission unit 22 transmits the counter information stored in the counter information storage unit 23 to the information processing system 50 with the SNMP, for example. An apparatus or software that transmits the counter information to the outside thereof with the SNMP is called an SNMP agent.

The counter information storage unit 23 stores at least the counter information, as illustrated in FIG. 8. FIG. 8 illustrates an example of the counter information stored in the counter information storage unit 23. The counter information represents the cumulative value of the number of pages printed after the shipment of the apparatus 20, and thus changes at each output from the apparatus 20. The counter information is stored in the form of a database called management information base (MIB), for example.

The counter information storage unit 23 may store executed print jobs. Each of the print jobs includes information such as the print page count, the user ID of the user having executed the printing, the print time, and print settings. The print jobs will be described in more detail later in a third embodiment of the present invention.

Referring back to FIG. 5, the terminal apparatus 30 includes a network communication unit 31, a display control unit 32, and an operation receiving unit 33. These functional units of the terminal apparatus 30 are functions or means implemented by the CPU 501 in FIG. 3 executing commands included in one or more programs installed in the terminal apparatus 30.

The function of the network communication unit 31 may be similar to that of the network communication unit 51 of the information processing system 50.

The display control unit 32 displays the setting screen, for example, based on the screen information received from the information processing system 50. The operation receiving unit 33 receives various user operations performed on the terminal apparatus 30, such as the operation performed on the setting screen.

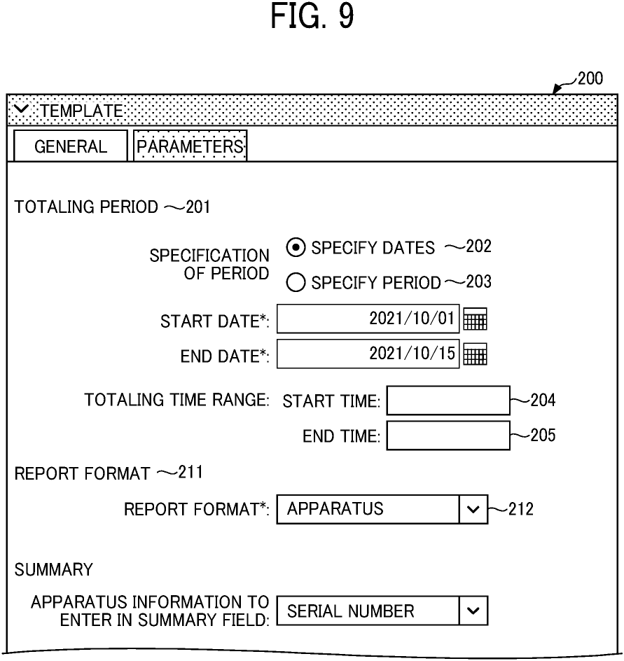

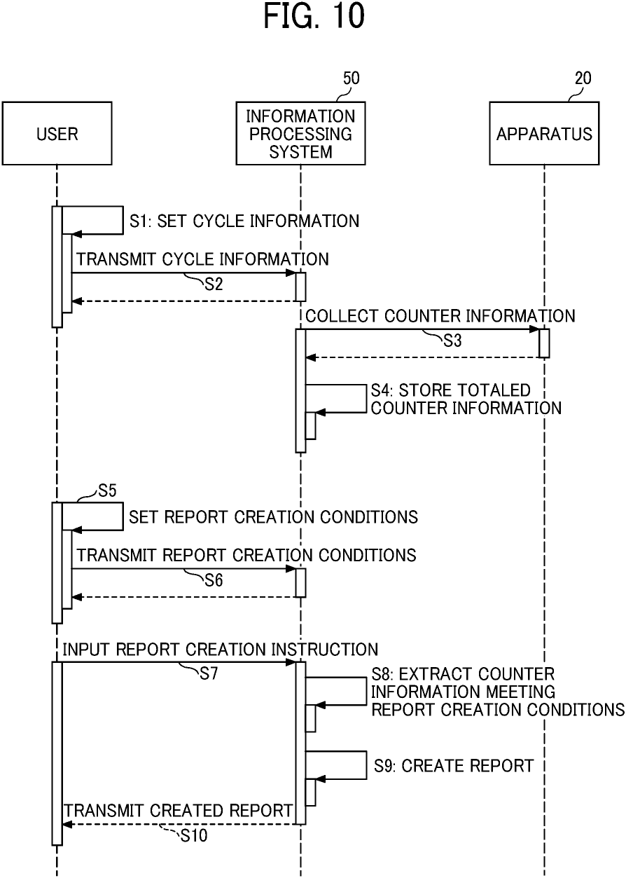

The setting of the time range information on the setting screen will be described with reference to FIG. 9.

FIG. 9 illustrates an example of a setting screen 200 displayed by the terminal apparatus 30. The setting of the time range information via the setting screen 200 in FIG. 9 is executed for each business office. The setting may be executed by a user of the business office. The information set on the setting screen 200 will be referred to as the report creation conditions.

Input fields included in the setting screen 200 will be described.

A totaling period field 201 is a field for the user to set a method of specifying the period by selecting a specify-by-date option 202 or a specify-by-period option 203. If the specify-by-period option 203 is selected, the user is prompted to set the start date and the end date of the period. The totaling period field 201 further includes a start time field 204 and an end time field 205. The start time of the time range information is set in the start time field 204, and the end time of the time range information is set in the end time field 205. The user may set a plurality of time range information items.

A report format field 211 includes a report format input field 212. The report format input field 212 is a field for the user to set the format of the report totaling the counter information, such as the report by apparatus, the report by user, or the report by department. The setting of the report creation conditions on the setting screen 200 is executed for each business office, and thus the totaling is assumed to be executed for each business office. The setting, however, may be made to total the counter information of a specified business office or total the counter information of different business offices together.

The cycle information as to every how many hours the counter information is to be acquired is also settable on the setting screen 200 by the user.

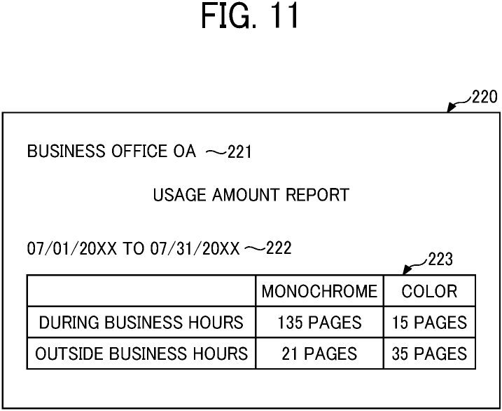

An operation procedure of the report creation with the time range information in the first embodiment will be described with reference to FIG. 10.

FIG. 10 is a sequence diagram illustrating an example of a process of the first embodiment in which the information processing system 50 totals the counter information with the time range information. In FIG. 10, a broken arrow line indicates a response message. The same applies to the subsequent sequence diagrams.

At step S1, the user connects the terminal apparatus 30 to the information processing system 50 to display the setting screen 200. The user sets, on the setting screen 200, the cycle information as to every how many hours the counter information is to be acquired.

The operation receiving unit 33 of the terminal apparatus 30 receives the settings.

At step S2, the network communication unit 31 of the terminal apparatus 30 transmits the cycle information to the information processing system 50. In the information processing system 50, the network communication unit 51 receives and stores the cycle information in the report creation condition storage unit 61.

At step S3, after the lapse of the time set in the cycle information, the acquisition unit 52 of the information processing system 50 requests the counter information from the apparatus 20 via the network communication unit 51. In response to the request, the network communication unit 21 of the apparatus 20 transmits to the information processing system 50 the counter information with the apparatus ID and the business office ID attached thereto.

Alternatively, the apparatus 20 may transmit the counter information to the information processing system 50 at a preset time, not in response to the request from the information processing system 50. This alternative is useful when the connection to the apparatus 20 from outside the company is restricted by a firewall, for example. Further, the apparatus 20 may transmit the counter information to the information processing system 50 at a preset time as well as in response to the request from the information processing system 50. For example, when the information processing system 50 fails to communicate with the apparatus 20, the apparatus 20 may transmit the counter information to the information processing system 50 by detecting that the counter information has not been transmitted for more than a certain time.

At step S4, the acquisition unit 52 of the information processing the system 50 stores the counter information in the counter information storage unit 62. If the cycle information is set to “every hour,” for example, the counter information is stored every hour.

At step S5, the terminal apparatus 30 displays the setting screen 200 generated by the screen generation unit 54 of the information processing the system 50. The user then sets, on the setting screen 200, the report creation conditions including the time range. Then, the operation receiving unit 33 of the terminal apparatus 30 receives the settings. The report creation conditions include the time range information.

At step S6, the network communication unit 31 of the terminal apparatus 30 transmits the report creation conditions to the information processing system 50 in accordance with the user operation. In the information processing system 50, the network communication unit 51 receives and stores the report creation conditions in the report creation condition storage unit 61.

At step S7, the user inputs a report creation instruction to the terminal apparatus 30, and the operation receiving unit 33 of the terminal apparatus 30 receives the report creation instruction. The network communication unit 31 of the terminal apparatus 30 transmits the report creation instruction to the information processing system 50, and the network communication unit 51 of the information processing system 50 receives the report creation instruction.

At step S8, the totaling unit 55 of the information processing system 50 acquires, from the counter information storage unit 62, the counter information meeting the report creation conditions. For example, it is assumed here that the report creation conditions specify the totaling for a certain month, and that the time range information is “9:00 to 15:00.” In this case, the totaling unit 55 calculates the difference between the counter information acquired at 9:00 and the counter information acquired at 15:00 in the counter information of the certain month. This difference corresponds to the counter information during the business hours.

The totaling unit 55 totals the counter information by apparatus and department (if the business office has more than one department) set in the report creation conditions, as well as by time range information.

If the counter information at the start time of the business hours or the counter information at the end time of the business hours is not stored in the counter information storage unit 62, the totaling unit 55 calculates the difference between the counter information of the first count after the start time of the time range information and the counter information of the last count before the end time of the time range information.

The totaling unit 55 further totals the counter information outside the business hours, i.e., outside the time range of 9:00 to 15:00 in the time range information. This is because the printing executed outside the business hours is also charged.

At step S9, the information output unit 53 of the information processing system 50 creates a report with the totaling result.

At step S10, the screen generation unit 54 of the information processing system 50 creates a Web page for displaying the report, and the network communication unit 51 of the information processing system 50 transmits the created Web page to the terminal apparatus 30. In the terminal apparatus 30, the network communication unit 31 receives the Web page, and the display control unit 32 displays the Web page to display the report.

An example of the output of the report will be described.

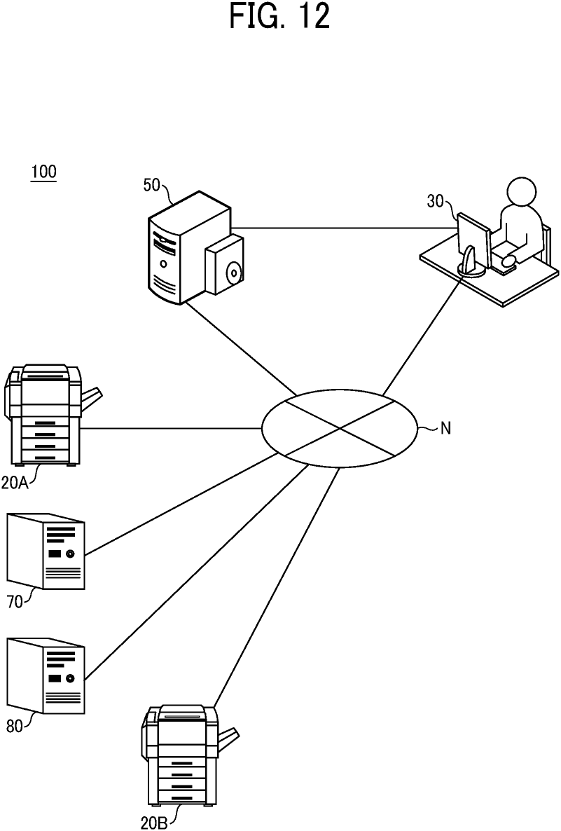

FIG. 11 illustrates an example of a report 220 created by the information output unit 53 of the information processing system 50. The report 220 may be displayed on the Web page displayed by the terminal apparatus 30, or may be printed out. In the report 220 of FIG. 11, a business office name 221, a totaling period 222, and a usage amount table 223 are displayed. The usage amount table 223 includes a print page count during the business hours and a print page count outside the business hours, thereby allowing the user to record the usage amount based on the account titles used in corporate accounting.

In the example of FIG. 11, the usage amount is displayed by business office. The terminal apparatus 30 may also display the report on the usage amount by apparatus 20 or by department. The usage amount by user is displayable if the counter information is collected as the print job.

The apparatus management system 100 of the first embodiment enables the creation of the report totaling the counter information during the business hours based on the time range information set by the user.

A second embodiment of the present invention will be described.

The following description of the second embodiment will be given of the information processing system 50 that creates the report by acquiring the business hours from an in-house information management system or a Web server and totaling the counter information by time range.

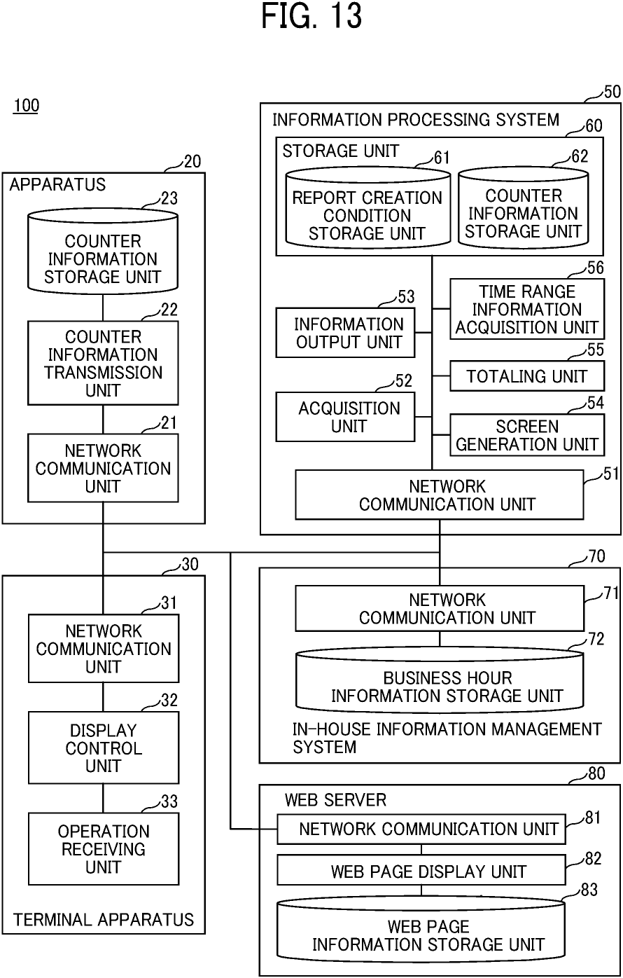

FIG. 12 is a diagram illustrating an example of the general arrangement of the apparatus management system 100 according to the second embodiment. The following description of the second embodiment with FIG. 12 will focus on differences from the first embodiment illustrated in FIG. 2.

The apparatus management system 100 of the second embodiment includes an in-house information management system 70 and a Web server 80.

The in-house information management system 70 holds the business hours of the business offices managed by the head office. The in-house information management system 70 provides the business hours via a published application programming interface (API), for example. Alternatively, the in-house information management system 70 may provide the business hours by electronic mail.

The Web server 80 is operated by each of the business offices or by a large commercial facility housing the business office. The Web server 80 provides the business hours of the business office via a Web page. For example, if the Web page has a description “Business Hours 9:00 to 17:00 on weekdays (Monday to Friday),” and if the combination of a number and a character “:” exists within a particular distance or a particular number of characters from the characters “Business Hours,” the information processing system 50 acquires the combination of the number and the character.

Functions of the apparatus management system 100 of the second embodiment will be described.

FIG. 13 is a functional block diagram illustrating an example of functional blocks of the information processing system 50, the terminal apparatus 30, the apparatus 20, the in-house information management system 70, and the Web server 80 according to the second embodiment.

The following description of the second embodiment with FIG. 13 will focus on differences from the first embodiment illustrated in FIG. 5.

The information processing system 50 of the second embodiment includes a time range information acquisition unit 56 in addition to the functional units of the information processing system 50 illustrated in FIG. 5. The time range information acquisition unit 56 acquires the time range information such as the business hours from the in-house information management system 70 or the Web server 80.

In the second embodiment, the report creation conditions stored in the report creation condition storage unit 61 are different from those illustrated in FIG. 6.

FIG. 14 illustrates an example of acquisition source information stored in the report creation condition storage unit 61. The acquisition source information is information related to the acquisition source. The acquisition source information is registered for each acquisition source. The acquisition source information may be the IP address (and an API key) of a server of the in-house information management system 70 (i.e., a head office server) publishing the business hours of the business offices or the uniform resource locator (URL) of the Web page describing the business hours of the business offices, for example. The acquisition source information such as the IP address or the URL is set on the setting screen 200 by the user. In FIG. 14, the illustration of the cycle information is omitted.

Referring back to FIG. 13, the in-house information management system 70 includes a network communication unit 71 and a business hour information storage unit 72. These functional units of the in-house information management system 70 are functions or means implemented by the CPU 501 in FIG. 3 executing commands included in one or more programs installed in the in-house information management system 70. The business hour information storage unit 72 is implemented by the HD 504 and the RAM 503 in FIG. 3, for example.

The function of the network communication unit 71 may be similar to that of the network communication unit 51 of the information processing system 50. The business hour information storage unit 72 stores the business hours of the business offices managed by the in-house information management system 70. The business hours may be stored for each business office.

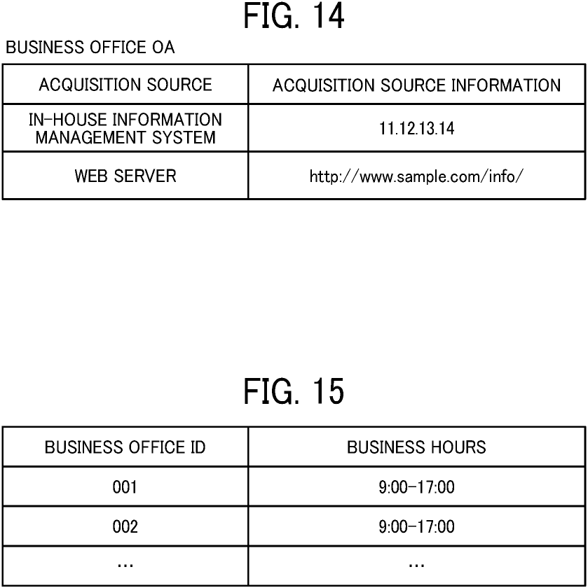

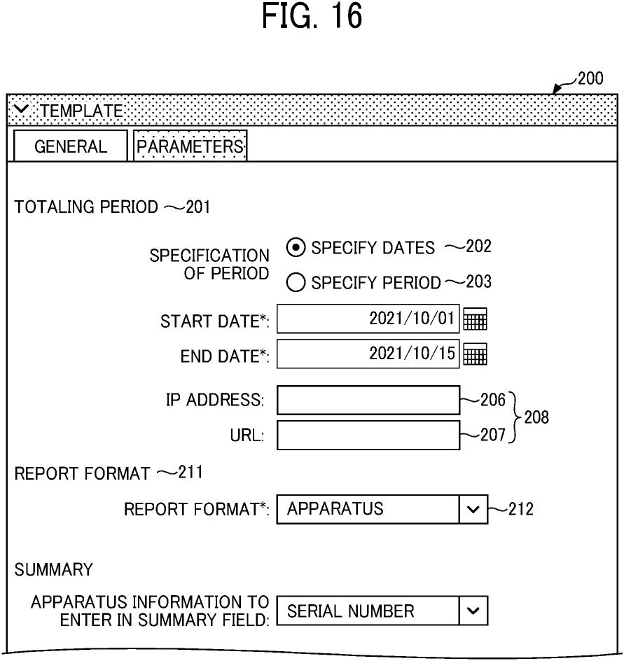

FIG. 15 illustrates an example of the business hours stored in the business hour information storage unit 72. As illustrated in FIG. 15, the business hours are stored in association with the business office ID, which is identification information for identifying the business office.

Referring back to FIG. 13, the Web server 80 includes a network communication unit 81, a Web page display unit 82, and a Web page information storage unit 83. These functional units of the Web server 80 are functions or means implemented by the CPU 501 in FIG. 3 executing commands included in one or more programs installed in the Web server 80. The Web page information storage unit 83 is implemented by the HD 504 and the RAM 503 in FIG. 3, for example.

The function of the network communication unit 81 may be similar to that of the network communication unit 51 of the information processing system 50. The Web page display unit 82 creates a Web page to be displayed by a Web browser with screen information stored in the Web page information storage unit 83. The screen information is described in HTML, XML, scripting language, and CSS, for example. The content of the Web page varies, and thus detailed description thereof will be omitted here.

The setting of the acquisition source of the business hours on the setting screen 200 will be described.

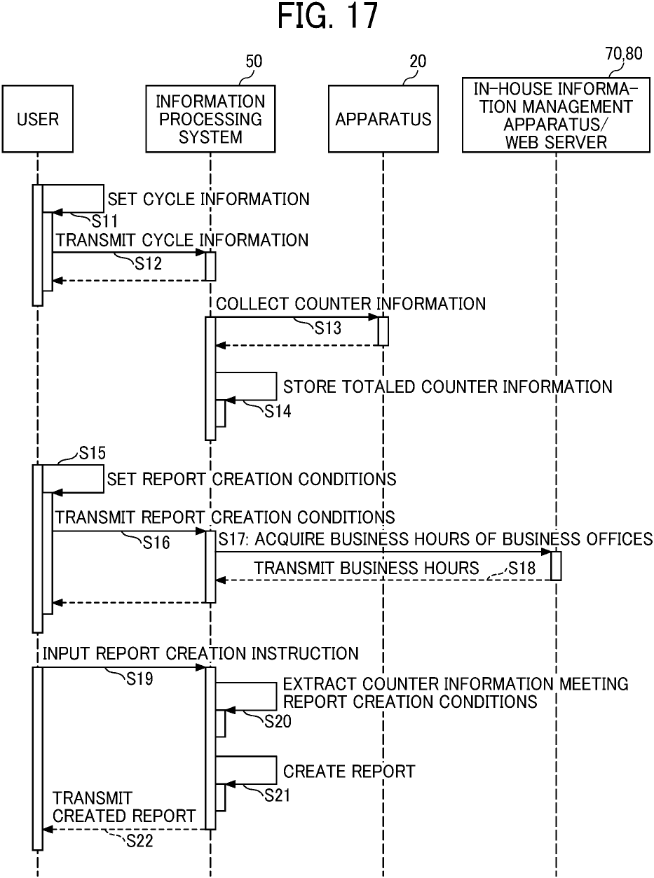

FIG. 16 illustrates an example of the setting screen 200 displayed by the terminal apparatus 30 in the second embodiment. The following description of the second embodiment with FIG. 16 will focus on differences from the first embodiment illustrated in FIG. 9.

In the setting screen 200 of the second embodiment, an acquisition source setting field 208 including an IP address field 206 and a URL field 207 replaces the field of the totaling time range in FIG. 9. The acquisition source of the business hours is set in the acquisition source setting field 208. If the acquisition source of the business hours is the Web server 80, the URL for accessing the Web page of the business office or the large commercial facility housing the business office is set in the URL field 207. If the acquisition source of the business hours is the in-house information management system 70, the IP address of the in-house information management system 70 is set in the IP address field 206. Both of the URL and the IP address may be set in the acquisition source setting field 208.

With the above-described settings, the information processing system 50 acquires the business hours of the business office (i.e., the time range information) from the in-house information management system 70 or the Web server 80.

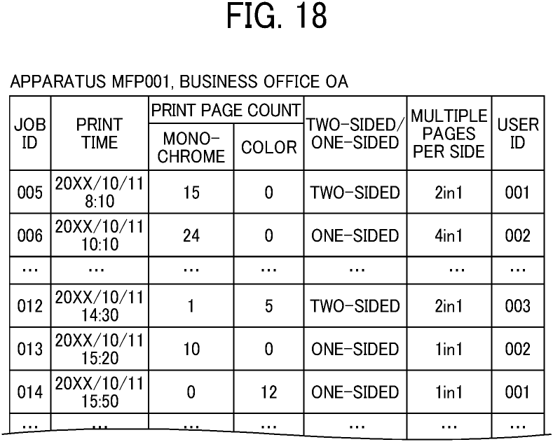

An operation procedure of the report creation with the time range information in the second embodiment will be described with reference to FIG. 17.

FIG. 17 is a sequence diagram illustrating an example of a process of the second embodiment in which the information processing system 50 totals the counter information with the time range information. The following description of the second embodiment with FIG. 17 will focus on differences from the first embodiment illustrated in FIG. 10. The processes of steps S11 to S14 may be similar to those of steps S1 to S4 in FIG. 10.

At step S15, the user sets, on the setting screen 200, the report creation conditions including the conditions in the acquisition source setting field 208. The operation receiving unit 33 of the terminal apparatus 30 receives the settings.

At step S16, the network communication unit 31 of the terminal apparatus 30 transmits the report creation conditions to the information processing system 50 in accordance with the user operation. In the information processing system 50, the network communication unit 51 receives and stores the report creation conditions in the report creation condition storage unit 61.

At steps S17 and S18, the time range information acquisition unit 56 of the information processing system 50 acquires the business hours of the business offices from the in-house information management system 70 or the Web server 80 based on the URL or the IP address in the acquisition source setting field 208 included in the report creation conditions. The business hours acquired from the in-house information management system 70 are associated with the business office IDs. With the business office ID corresponding to the user identified through his or her login to the information processing system 50, therefore, the business hours to be used by the totaling unit 55 in the totaling are identified. If the time range information acquisition unit 56 accesses the Web server 80, the time range information acquisition unit 56 has access to the description of the business hours in part of the Web page provided by the Web server 80. The time range information acquisition unit 56 therefore detects the characters “9:00 to 15:00” within a particular distance or a particular number of characters from the characters “Business Hours,” for example.

The subsequent processes of steps S19 to S22 may be similar to those of steps S7 to S10 in FIG. 10. For example, it is assumed here that the report creation conditions specify the totaling for a certain month, and that the time range information is “9:00 to 15:00.” In this case, the totaling unit 55 calculates the difference between the counter information acquired at 9:00 and the counter information acquired at 15:00 in the counter information of the certain month. This difference corresponds to the counter information during the business hours.

The apparatus management system 100 of the second embodiment enables the creation of the report totaling the counter information during the business hours based on the time range information acquired from the in-house information management system 70 or the Web server 80.

A third embodiment of the present invention will be described.

The following description of the third embodiment will be given of the information processing system 50 that totals the usage amount based on the print page counts included in the job logs. Further, the hardware configuration diagrams of FIGS. 3 and 4 and the functional block diagram of FIG. 5 described above in the first embodiment will be referred to in the following description of the third embodiment.

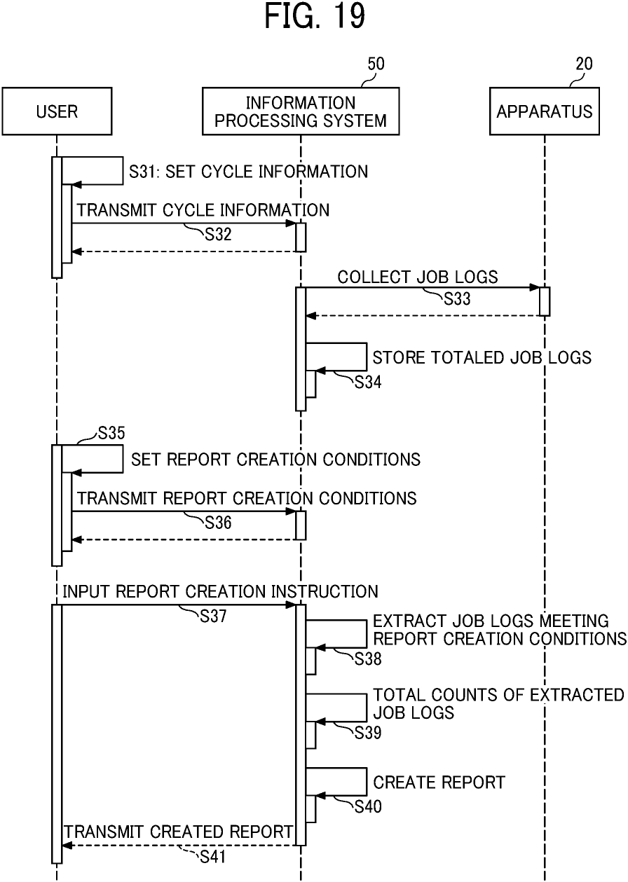

FIG. 18 illustrates job logs stored in the counter information storage unit 62 of the third embodiment. Each of the job logs includes items such as “job ID,” “print time,” “print page count,” “two-sided/one-sided,” “multiple pages per side,” and “user ID.” The job logs are stored by apparatus 20 and by business office.

The item “job ID” is identification information of a print job for uniquely identifying the print job. The item “print time” represents the time of receiving or terminating the print job. The item “print page count” represents the number of monochrome printed pages and the number of color printed pages in the print job. The item “two-sided/one-sided” indicates which of two-sided printing and one-sided printing has been performed. The item “multiple pages per side” represents the number of pages printed on one side of a sheet in multiple-pages-per-side printing. The item “user ID” is identification information for identifying the user who has executed the print job. The user ID is identified through the login of the user to the apparatus 20.

The job logs as illustrated in FIG. 18 are held by the information processing system 50. The totaling unit 55 of the information processing system 50 therefore identifies the print jobs during the business hours based on the print time, and adds up the monochrome print page counts and the color print page counts of the print jobs. Consequently, the usage amount during the business hours is totaled similarly as in the case in which the counter information is transmitted to the information processing system 50.

An operation procedure of the report creation with the time range information in the third embodiment will be described with reference to FIG. 19.

FIG. 19 is a sequence diagram illustrating an example of a process of the third embodiment in which the information processing system 50 totals the print page count with the time range information. The following description of the third embodiment with FIG. 19 will focus on differences from the first embodiment illustrated in FIG. 10.

At step S31, the user connects the terminal apparatus 30 to the information processing system 50 to display the setting screen 200. The user sets, on the setting screen 200, the cycle information as to every how many hours the job logs are to be acquired. The operation receiving unit 33 of the terminal apparatus 30 receives the settings. The setting screen 200 may be similar to that illustrated in FIG. 9.

At step S32, the network communication unit 31 of the terminal apparatus 30 transmits the cycle information to the information processing system 50. In the information processing system 50, the network communication unit 51 receives and stores the cycle information in the report creation condition storage unit 61.

At step S33, after the lapse of the time set in the cycle information, the acquisition unit 52 of the information processing system 50 requests the job logs from the apparatus 20 via the network communication unit 51. In response to the request, the network communication unit 21 of the apparatus 20 transmits to the information processing system 50 the job logs with the apparatus ID and the business office ID attached thereto.

At step S34, the acquisition unit 52 stores the job logs in the counter information storage unit 62. If the cycle information is set to “every hour,” for example, the job logs for one hour are stored every hour.

At step S35, the user sets, on the setting screen 200, the report creation conditions including the time range. The operation receiving unit 33 of the terminal apparatus 30 receives the settings.

At step S36, the network communication unit 31 of the terminal apparatus 30 transmits the report creation conditions to the information processing system 50 in accordance with the user operation. In the information processing system 50, the network communication unit 51 receives and stores the report creation conditions in the report creation condition storage unit 61.

At step S37, the user inputs a report creation instruction to the terminal apparatus 30, and the operation receiving unit 33 of the terminal apparatus 30 receives the report creation instruction. The network communication unit 31 of the terminal apparatus 30 transmits the report creation instruction to the information processing system 50, and the network communication unit 51 of the information processing system 50 receives the report creation instruction.

At step S38, the totaling unit 55 of the information processing system 50 acquires, from the counter information storage unit 62, the print jobs meeting the report creation conditions. For example, it is assumed here that the report creation conditions specify the totaling for a certain month, and that the time range information is “9:00 to 15:00.” In this case, the totaling unit 55 acquires, from the print jobs of the certain month stored in the counter information storage unit 62, the print jobs with the print time after 9:00 and before 15:00.

At step S39, the totaling unit 55 totals (i.e., adds up) the color print page counts and the monochrome print page counts of the print jobs with the print time after 9:00 and before 15:00.

The totaling unit 55 further totals the print page counts of the print jobs executed outside the business hours, i.e., outside the time range of 9:00 to 15:00 in the time range information. This is because the printing executed outside the business hours is also charged.

At step S40, the information output unit 53 of the information processing system 50 creates a report with the totaling result.

At step S41, the screen generation unit 54 of the information processing system 50 creates a Web page for displaying the report, and the network communication unit 51 of the information processing system 50 transmits the created Web page to the terminal apparatus 30. In the terminal apparatus 30, the network communication unit 31 receives the Web page, and the display control unit 32 displays the Web page to display the report.

Although the user sets the time range information in the process of FIG. 19, the information processing system 50 in the third embodiment may acquire the business hours from the in-house information management system 70 or the Web server 80 similarly as in the second embodiment.

The apparatus management system 100 of the third embodiment enables the creation of the report totaling the print page counts of the print jobs during the business hours based on the time range information set by the user.

For example, the account classification in corporate accounting is based on whether the costs are generated during the business hours. According to a typical technique, the report is created without the distinction of whether the costs are generated during the business hours. The foregoing embodiments, on the other hand, enable the distinction between the print jobs executed during the business hours and the print jobs executed outside the business hours.

In the foregoing embodiments, the information processing system 50 totals the usage amount during the time range of the business hours. The usage amount, however, may be totaled for any time range, such as during the working hours, outside the working hours, or during the overtime working hours.

In the configuration examples illustrated in drawings such as FIG. 5, the processing units of the apparatus 20, the information processing system 50, and the terminal apparatus 30 are divided in accordance with major functions thereof for the purpose of facilitating the understanding of the processing thereof. The invention of the present application is not limited by how the processing units are divided or the names of the processing units. The processing of the apparatus 20, the information processing system 50, and the terminal apparatus 30 may be divided into a larger number of processing units in accordance with the processing. Further, each of the processing units may be subdivided to include more processes.

The apparatuses described in each of the embodiments disclosed in the present specification form one of a plurality of computing environments for implementing the embodiment. In an embodiment of the present invention, the information processing system 50 is a server cluster including a plurality of computing devices configured to communicate with each other via a desired type of communication link such as a network or a shared memory, for example, to execute the processes disclosed in the present specification.

Further, the information processing system 50 may be configured such that the disclosed processing steps, such as those illustrated in FIG. 10, for example, are shared in various combinations. For instance, the process executed by a particular unit may be executed by a plurality of information processing apparatuses included in the information processing system 50. The components of the information processing system 50 may be integrated in a single server, or may be distributed to a plurality of apparatuses.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing system comprising circuitry configured to
acquire usage amount information from an apparatus via a network, the usage amount information being related to a usage amount of the apparatus,
total the usage amount for a time range, and
output the totaled usage amount in association with the time range.

2. The information processing system of claim 1, wherein the time range corresponds to business hours of a business office in which the apparatus is installed, and
wherein the circuitry totals the usage amount during the business hours and the usage amount outside the business hours.

3. The information processing system of claim 1, wherein the circuitry further
generates a setting screen for receiving settings of the time range,
transmits screen information of the generated setting screen to the apparatus, and
totals the usage amount for the time range set on the setting screen and transmitted from the apparatus.

4. The information processing system of claim 1, wherein the circuitry further
generates a setting screen for receiving settings of acquisition source information of an acquisition source that provides the time range,
transmits screen information of the generated setting screen to the apparatus,
acquires the time range based on the acquisition source information set on the setting screen and transmitted from the apparatus, and
totals the usage amount for the acquired time range.

5. The information processing system of claim 1, wherein the usage amount information corresponds to counter information representing a count of prints performed by the apparatus,
wherein the circuitry periodically acquires the counter information from the apparatus and stores the counter information in association with an acquisition time of the counter information, and
wherein in response to receipt of a request for totaling, the circuitry separately totals the counter information with the acquisition time falling within time range and the counter information with the acquisition time falling outside the time range.

6. The information processing system of claim 1, wherein the usage amount information corresponds to a job log including a print page count and a print time of a print performed by the apparatus,
wherein the circuitry periodically acquires the job logs from the apparatus, and
wherein in response to receipt of a request for totaling, the circuitry separately totals the print page count with the print time falling within time range and the print page count with the print time falling outside the time range.

7. The information processing system of claim 4, wherein the time range corresponds to business hours of a business office in which the apparatus is installed, and
wherein the acquisition source information represents a uniform resource locator of a world wide web server that provides a description of the business hours, or represents an internet protocol address of a head office server that provides the business hours.

8. An information output method comprising:
acquiring usage amount information from an apparatus via a network, the usage amount information being related to a usage amount of the apparatus;
totaling the usage amount for a time range; and
outputting the totaled usage amount in association with the time range.

9. A non-transitory recording medium which, when executed by one or more processors, causes the processors to perform an information output method, the method comprising:
acquiring usage amount information from an apparatus via a network, the usage amount information being related to a usage amount of the apparatus;
totaling the usage amount for a time range; and
outputting the totaled usage amount in association with the time range.
